(19) United States
(12) Patent Application Publication
(10) Pub. No.: US 2013/0340264 A1
(43) Pub. Date: Dec. 26, 2013

(54) DEPTH STOP FOR AN OSCILLATING TOOL

(71) Applicant: C. & E. Fein GmbH, Schwaebisch Gmuend - Bargau (DE)

(72) Inventors: Fabian BEK, Boebingen (DE); Heinrich WEBER, Schwaebisch Gmuend (DE)

(21) Appl. No.: 13/910,439

(22) Filed: Jun. 5, 2013

(30) Foreign Application Priority Data
Jun. 25, 2012 (DE) 10 2012 105 520.3

(51) Int. Cl. B23D 59/00; B23Q 16/00

(52) U.S. Cl. CPC B23D 59/00; B23Q 16/001
USPC 30/377; 30/505

(57) ABSTRACT

The description shows a depth stop for an oscillating tool 1, wherein a saw blade for machining of a worlcpieee is mountable to the tool 1, wherein the depth stop 16 has a spacer 2 for adjusting a penetration depth of the saw blade into the workpiece, a fixture device 9 on which the spacer (2) is fixable and a mounting member 5 to which the fixture device 9 is mountable, wherein the mounting member 5 is firmly attachable or firmly attached to the tool 1, wherein in a first state the mounting member 5 is immovable relative to the fixture device 9 and wherein in a second state the mounting member 5 is rotatable or movable relative to the fixture device 9 at least around or along an axis of motion 21.

### FIELD OF THE INVENTION

The present invention relates to a depth stop for an oscillating tool, an oscillating tool and a system for oscillating machining of a workpiece.

### BACKGROUND OF THE INVENTION

In prior art oscillating tools are known which have a depth stop with which a predetermined penetration depth for example when sawing into a workpiece can be ensured. It is known that such depth stops can be equipped with a support surface for guiding the depth stop on a surface of a workpiece.

### SUMMARY OF THE INVENTION

In the case of a depth stop which is firmly attached to a tool, it can become necessary, particularly in limited space working areas, to loosen and relock the connection between tool and depth stop several times according to the current space available during the machining process. This may make the machining of a workpiece more difficult. Furthermore a permanent connection between tool and depth stop leads to the tool not being able to be moved during the machining process. For example “rocking free” or “prying free” of the saw blade is in this case impossible, which can in turn lead to an unwanted temperature increase of the saw blade.

One object is therefore to provide a depth stop for an oscillating tool, which allows for a relative rotation between the tool and the depth stop around the axis of motion of the saw blade even in a fixed depth setting.

To oscillating tools offset saw blades or straight saw blades can be mounted. For example when retooling from an offset saw blade to a straight saw blade a different distance from tool to saw blade may result, in which case an existing stop for positioning the saw blade relative to the workpiece has to be readjusted. Readjusting the stop can be time consuming

A further object is therefore to provide a device for an oscillating tool, which makes adjusting a stop easier or even unnecessary, particularly when retooling the tool from an offset saw blade to a straight saw blade or vice versa.

As a first embodiment of the invention a depth stop for an oscillating tool is provided, wherein a saw blade for machining of a workpiece is mountable to the tool, wherein the depth stop has: a spacer for adjusting a penetration depth of the saw blade into the workpiece, a fixture device on which the spacer is fixable and a mounting member on which the fixture device is mountable, wherein the mounting member is firmly attachable or firmly attached to the tool, wherein in a first state the mounting member is immovable relative to the fixture device and wherein in a second state the mounting member is rotatable or movable relative to the fixture device at least around or along an axis of motion.

The embodiment creates a possibility of movement between tool and workpiece or depth stop, respectively, which allows for an adaption to spatial conditions of the work place. In addition a “prying free” for example during a jam of the saw blade in the workpiece or aid in chip removal is made possible. A maximum penetration depth of the saw blade is still enabled. If a movement between tool and depth stop is not desired, the embodiment allows setting a rigid connection between tool and depth stop.

As a second embodiment of the invention an oscillating tool is provided, comprising a depth stop according to any one of claims 1 to 5.

As a third embodiment of the invention a system for oscillating machining of a workpiece is provided, comprising: a tool according to claim 6, with a first sliding member and a guide rail with a second sliding member, wherein the first sliding member is configured to be engaged or is engaged with the second sliding member, which makes the tool supportable and/or guidable by the guide rail.

Exemplary embodiments are described in the dependent claims.

According to an exemplary embodiment of the invention a depth stop is provided, wherein the fixture device has a first annular section with a first axis of rotation, wherein the first annular section is configured to coact with a second annular section of the mounting member with a second axis of rotation.

By means of the first annular section coacting with the second annular section, a rotational movement in particular of the tool with respect to the locked and fixed depth stop can be enabled.

In a further embodiment according to the invention a depth stop is provided, wherein in the second state the mounting member is rotatable around the fixture device, wherein the axis of motion corresponds to the first and the second axis of rotation.

According to an exemplary embodiment of the invention a depth stop is provided, wherein in the first state the first annular section is tensioned with the second annular section.

Advantageously, as an alternative a firm, fixed connection between tool and depth stop can be established, wherein the tool has no way of moving with respect to the depth stop.

According to further exemplary embodiment of the present invention a depth stop is provided, wherein the spacer comprises a support surface, wherein the support surface has a first width distance along the width of the support surface originating at the longitudinal axis towards an end of the support surface and a second width distance along the width of the support surface originating at the longitudinal axis towards the opposite end of the support surface, wherein the first width distance is different from the second width distance.

By means of different width distances of the support surface different distances to a yet to be mounted stop can be achieved, which secures an flush alignment of the saw blade mounted to the tool. This is advantageous for example when retooling from an offset saw blade to a straight saw blade or vice versa, particularly in combination with a guide rail.

According to a further exemplary embodiment of the present invention a system is provided, wherein the first sliding member is formed complementary to the second sliding member.

By means of a complementary formation of the first sliding member to the second sliding member a simple engagement of the individual system members can be achieved.

According to an exemplary embodiment of the invention a system is disclosed, wherein the first sliding member or the second sliding member is a T-slot, a recess for a dovetail or a u-shaped formation and wherein the second sliding member or the first sliding member is a support surface for a T-slot, a dovetail for the recess or a web.

A combination of a T-slot with a support surface for the T-slot or a recess for a dovetail and a dovetail, respectively, or a web and a complementary u-shape for the web, respectively, constitute a, with regard to manufacturing, cost-efficient implementation of a situation of a positive fit of individual system members.

According to an exemplary embodiment of the invention a system is disclosed, wherein the guide rail has on one side and/or on both sides a section for the flush alignment of a saw blade mounted to the tool.

By means of positioning a protruding section, the fact that offset saw blades or straight saw blades can be mounted to the tool can be taken into account. If an offset saw blade is mounted, the guide rail can be turned in such a way, that the protruding section is positioned in between the tool and the saw blade. If a straight saw blade is mounted to the tool, the guide rail can be used in such a way, that no protruding section is positioned between the tool and the saw blade. Because of this, a flush alignment of the saw blade to the guide rail can be ensured in different situations (offset saw blade or straight saw blade mounted to the tool).

It can be considered an idea of the invention to provide a depth stop for an oscillating tool, which allows for a limited amount of movement even in fixed setting of the depth stop and wherein furthermore a quick and easy adjustment to a changed work situation for example when retooling from an offset saw blade to a straight saw blade is made possible.

Of course individual features can be combined with each other interchangeably, which may enable advantageous effects surpassing the total of individual effects.

### SHORT DESCRIPTION OF THE DRAWINGS

Further details and advantages are made clear by the exemplary embodiments shown in the drawings. There is shown by

FIG. 1 an oscillating tool with a depth stop,

FIG. 2 a depth stop with a support surface, a fixture device and a mounting member for mounting to the oscillating tool,

FIG. 3 an exploded view of the depth stop with the support surface, the fixture device and the mounting member for mounting to the oscillating tool,

FIG. 4 an oscillating tool guided in a guide rail, wherein an offset saw blade is mounted to the tool,

FIG. 5 a further oscillating tool guided in a guide rail, wherein a straight saw blade is mounted to the tool,

FIG. 6 a further oscillating tool guided in a guide rail, wherein an offset saw blade is mounted to the tool,

FIG. 7 a further oscillating tool guided in a guide rail, wherein a straight saw blade is mounted to the tool,

FIG. 8 a further oscillating tool guided in a guide rail, wherein an offset saw blade is mounted to the tool,

FIG. 9 a support surface in a top view (as looked at from a respective tool).

### DETAILED DESCRIPTION OF EXEMPLARY EMBODIMENTS

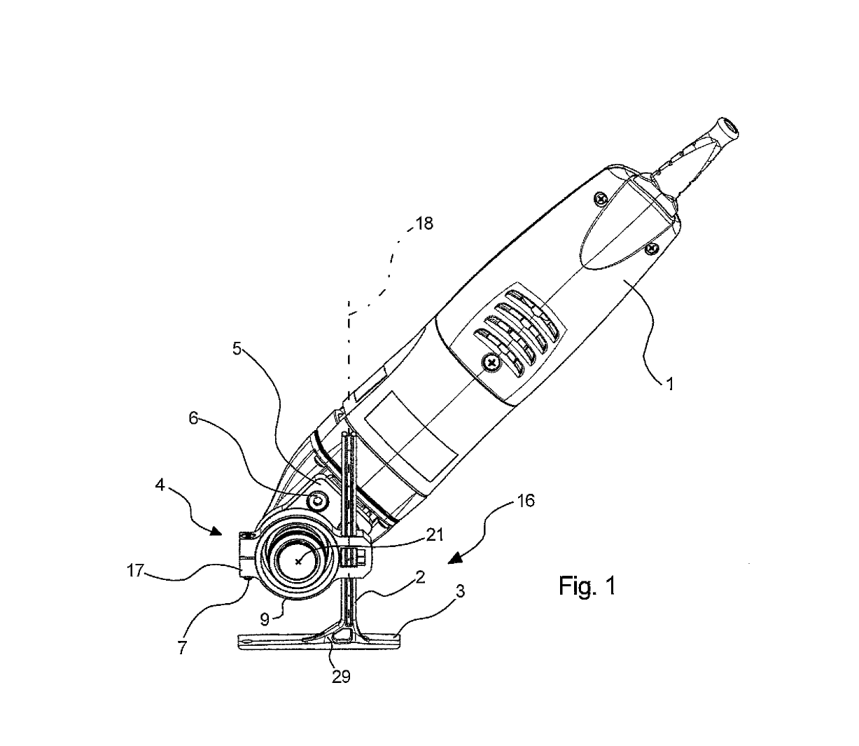

FIG. 1 shows an oscillating tool with a depth stop 16, which comprises a support surface 3, a spacer 2, a fixture device 9 and a mounting member 5. The support surface 3 serves as secure footing of the tool. By adjusting the spacer 2 precise machining and penetration depth during machining of a workpiece can be ensured.

The spacer 2 is fixed to a fixture device 9. The fixture device 9 is connected to the mounting member 5 by means of a clamping device 4 having clamp jaws 17. By means of a clamp bolt 7 the clamp jaws can be tightened and the fixture device be tensioned with the mounting member 5. Alternatively the clamp jaws 17 can only be tightened lightly, which keeps the fixture device movable to the mounting member 5 and allows the tool 1 to be rotated around the rotational axis 21 with unchangeably set depth stop. The mounting member 5 can for example be firmly attached with bolts 6 to the tool 1.

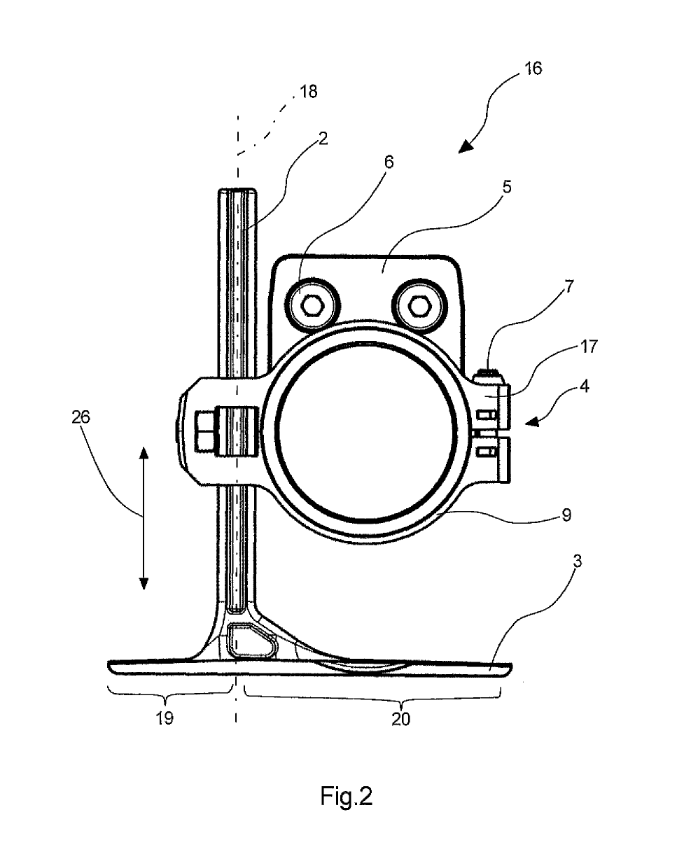

FIG. 2 shows a depth stop 16 with a support surface 3, a fixture device 9, to which a spacer 2 can be mounted and the mounting member 5, which can be firmly attached to the corresponding tool (not shown). The fixture device 9 can be clamped to the mounting member 5 either firmly or in a still moveable way by means of the clamp jaws 17 of the clamping device 4. The machining depth can be set by adjusting the tool's distance to the support surface 3 along the moving direction 26.

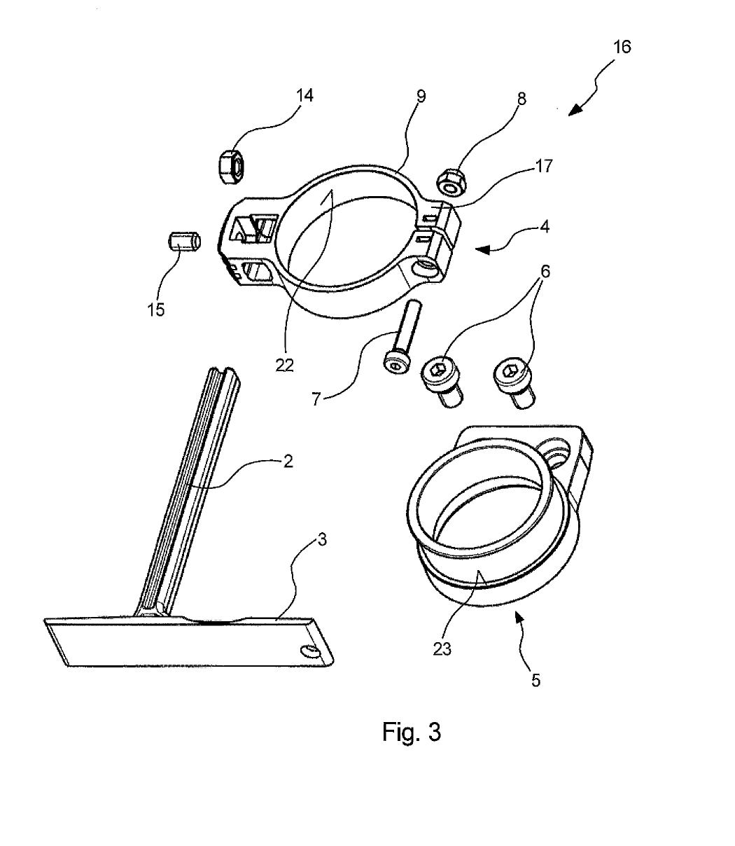

FIG. 3 shows the depth stop 16 with the support surface 3, the fixture device 9 and the mounting member 5 in an exploded view. The spacer 2 can be firmly attached to the fixture device 9 with locking members 14, 15, whereby a distance of the cutting edges or the saw blade, respectively, of the tool to the work piece is defined. The fixture device 9 can be placed on the mounting member 5 and can be by means of for example a bolt 7 and a nut 8 clamped/tensioned to the mounting member 5 or just attached together. The mounting member 5 can be attached to the corresponding tool (not shown) by means of bolts 6. If the clamp jaws 17 of the clamping device 4 are just lightly tightened via the clamp bolt 7, a firm joint between tool and depth stop is achieved, nevertheless in this state an annular section 22 of the fixture device 9 can be configured to coact with the annular section 23 of the mounting member in such a way, that the tool can be rotated with respect to the depth stop 16 with the distance of the workpiece to the cutting edges or the saw blade, respectively, set.

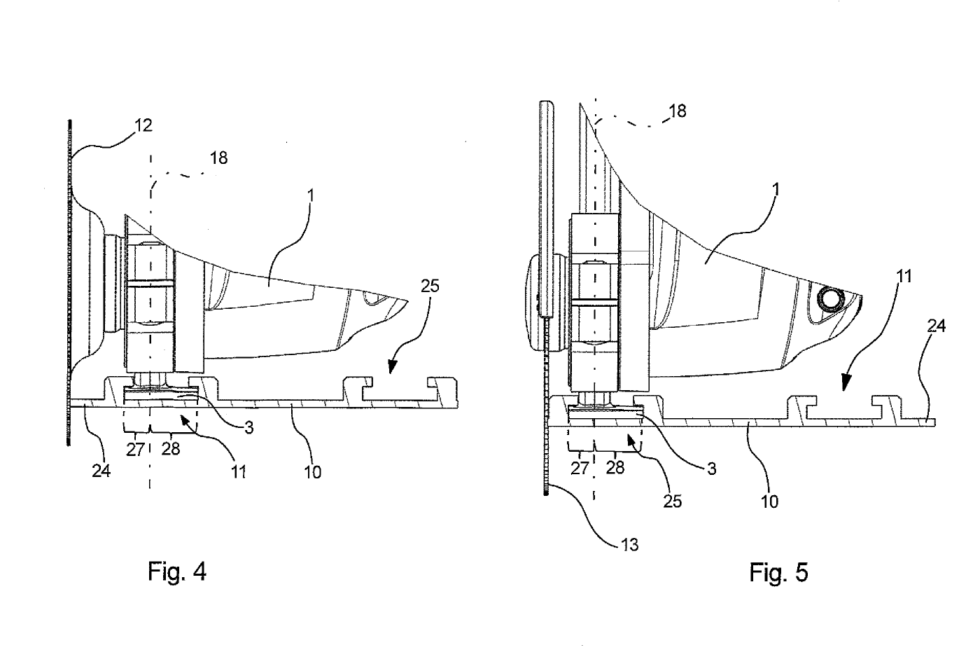

FIG. 4 shows a tool 1 with an offset saw blade 12, which can be guided by a guide rail 10 with a T-slot 11. In this case the guide rail 10 is arranged in such a way, namely with respect to the projecting section/protrusion 24, that the larger distance of the offset saw blade 12 to the tool 1, compared to a straight saw blade, can be compensated and the saw blade 12 can guided flush with the edge of the guide rail 10.

FIG. 5 shows a tool 1 with a straight saw blade 13, which can be guided by a guide rail 10. In this case the guide rail 10 is rotated 180° compared to FIG. 4, which moves the projecting section 24 to the right (according to the plane of projection). Due to the asymmetric formation of the guide rail 10 with the projecting section 24, retooling from an offset saw blade to a straight saw blade can be taken into account.

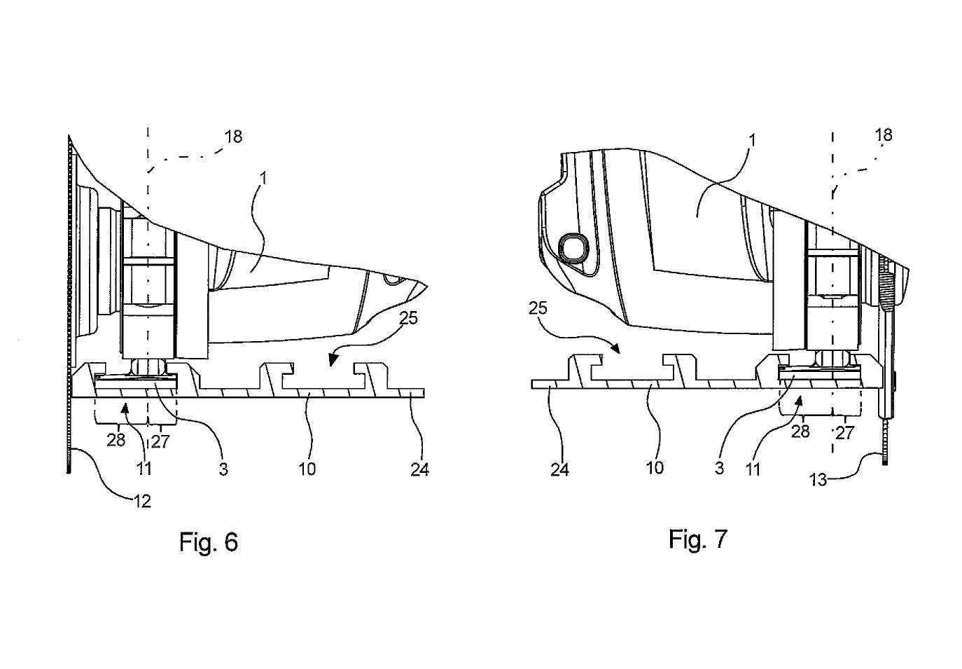

FIG. 6 shows a guide rail 10 in a longitudinal cross section and a tool 1 in a longitudinal view, wherein the support surface 3 engages in the T-slot 11. The tool 1 is guided by the T-slot 11. The support surface 3 has a variable width offset with a first width distance 27 and a second width distance 28 from the longitudinal axis 18.

Because of this the distance of the saw blade 12 to the guide rail 10 can be, depending on the first width distance 27 or the second width distance 28 pointing to the left (with respect to the view in FIG. 6), adjusted in such a way, that the saw blade is arranged/oriented flush with the guide rail 10.

FIG. 7 shows a tool 1 with a support surface 3, wherein the first width distance 27 points towards the saw blade 13 and the second width distance 28 points away from the saw blade 13, By arranging the support surface 3 with the first width distance 27 pointing forward, a flush alignment of the saw blade 13 with the guide rail 10 can be ensured.

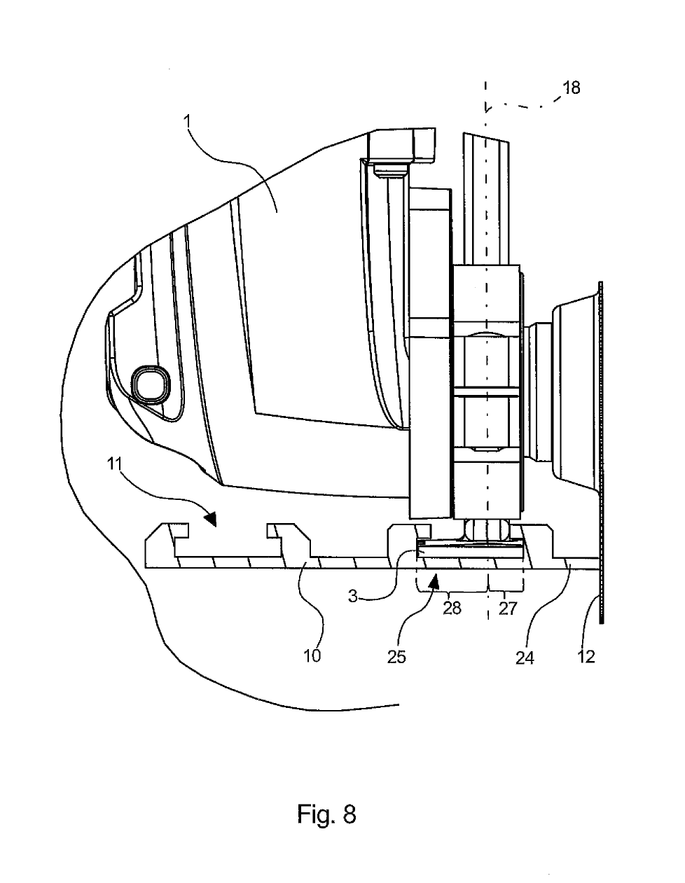

FIG. 8 shows a tool 1 with a support surface 3 with a first width distance 27 pointing towards the saw blade 12. The guide rail 10 has a protrusion 24. Therefore in total 4 situations can be set up to achieve a flush alignment of the concerning saw blade with a guide rail. The first situation would be no protrusion of the guide rail between tool and saw blade and the first width distance pointing towards the saw blade. The second situation would be no protrusion of the guide rail between tool and saw blade and the second width distance pointing towards the saw blade. The third situation would be a protrusion of the guide rail between tool and saw blade and the first width distance pointing towards the saw blade. The fourth situation would be a protrusion of the guide rail between tool and saw blade and the second width distance pointing towards the saw blade.

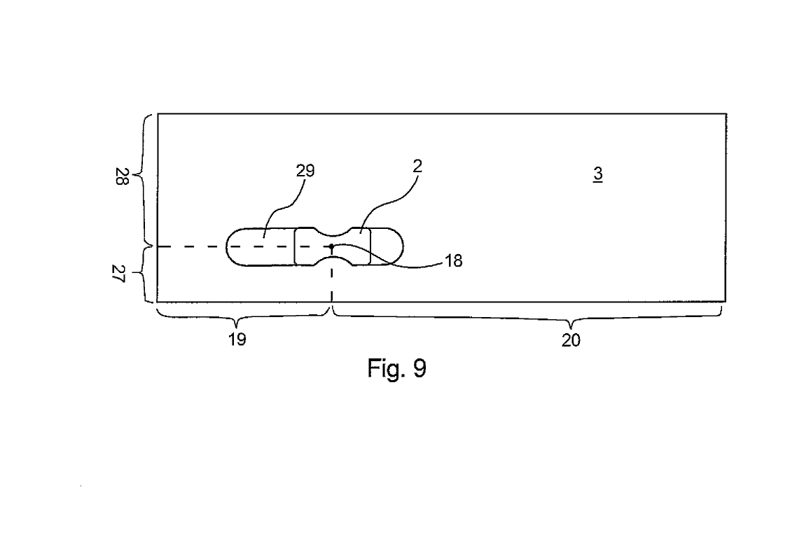

FIG. 9 shows a support surface 3 with a first width distance 27 and a second width distance 28 and a first length distance 19 and a second length distance 20, wherein the distances in each case originate at the longitudinal axis 18 end at the respective edge of the support surface 3.

It shall be mentioned that the term “have” does not preclude further elements or procedural steps, just as the terms “a” does not preclude multiple elements and steps.

The reference numerals used only serve to increase the comprehensibility and should in no case be considered restricting, wherein the scope of protection of the invention is expressed by the claims.

### LIST OF REFERENCE NUMERALS

1 oscillating tool

2 spacer

3 support surface

4 clamping device

5 mounting member

6 bolt

7 clamp bolt

8 nut

9 fixture device

10 guide rail

11 T-slot

12 saw blade

13 saw blade

14 locking member

15 locking member

16 depth stop

17 clamp jaws

18 longitudinal axis of the spacer

19 first length distance

20 second length distance

21 axis of motion

22 first annular section

23 second annular section

24 section/protrusion of the guide rail

25 T-slot

26 direction of adjustment

27 first width distance

28 second width distance

29 foot of the spacer

1. A depth stop (16) for an oscillating tool (10), wherein a saw blade for machining of a workpiece is mountable to the tool, wherein the depth stop (16) has
a spacer (2) for adjusting a penetration depth of the saw blade into the workpiece,
a fixture device (9) on which the spacer (2) is fixable and
a mounting member (5) to which the fixture device (9) is mountable, wherein the mounting member (5) is firmly attachable or firmly attached to the tool (1),
wherein
in a first state the mounting member (5) is immovable relative to the fixture device (9) and wherein in a second state the mounting member (5) is rotatable or movable relative to the fixture device (9) at least around or along an axis of motion (21).

2. The depth stop (16) according to claim 1, wherein the fixture device (9) has a first annular section (22) with a first axis of rotation, wherein the first annular section (22) is configured to coact with a second annular section (23) of the mounting member (5) with a second axis of rotation.

3. The depth stop according to claim 2, wherein in the second state the mounting member (5) is rotatable around the fixture device (9), wherein the axis of motion (21) corresponds to the first and the second axis of rotation.

4. The depth stop (16) according to claim 2, wherein in the first state the first annular section (22) is tensioned with the second annular section (23).

5. The depth stop (16) according to claim 1, wherein the spacer comprises a support surface (3), wherein the support surface has a first width distance (27) along the width of the support surface (3) originating at the longitudinal axis (18) towards an end of the supporting surface (3) and a second width distance (28) along the width of the supporting surface (3) originating at the longitudinal axis (18) towards the opposite end of the supporting surface (3), wherein the first width distance (27) is different from the second width distance (28).

6. An oscillating tool comprising a depth stop according to claim 1.

7. A system for oscillating machining of a workpiece, comprising
a tool according to claim 6 with a first sliding member (3) and
a guide rail (10) with a second sliding member (11, 25), wherein
the first sliding member (3) is configured to be engaged or is engaged with the second sliding member, which makes the tool supportable and/or guidable by the guide rail (10).

8. The system according to claim 7, wherein the first sliding member is formed complementary to the second sliding member.

9. The system according to claim 8, wherein the first sliding member or the second sliding member is a T-slot, a recess for a dovetail or a u-shaped formation and wherein the second sliding member or the first sliding member is a support surface (3) for the T-slot, a dovetail for the recess or a web.

10. The system according to claim 7, wherein the guide rail (10) has on one and/or on both sides a section (24) for flush alignment of a saw blade mounted to the tool.
